(19) United States
(12) Patent Application Publication
(10) Pub. No.: US 2010/0042911 A1
(43) Pub. Date: Feb. 18, 2010

(54) SYSTEM AND METHOD FOR PROVIDING CONTENT ON A MOBILE DEVICE BY CONTROLLING AN APPLICATION INDEPENDENT OF USER ACTION

(75) Inventors: Christopher R. Wormald, Waterloo (CA); Martyn Henri Mallick, Waterloo (CA); James Laurence Balsillie, Waterlo (CA)

Correspondence Address: Blake, Cassels & Graydon LLP, 199 BAY STREET , SUITE 2800, COMMERCE COURT WEST, TORONTO, ON, M5L 1A9, CA

(73) Assignee: RESEARCH IN MOTION LIMITED, Waterloo (CA)

(21) Appl. No.: 12/507,389

(22) Filed: Jul. 22, 2009

Related U.S. Application Data
(60) Provisional application No. 61/087,029, filed on Aug. 7, 2008.

(51) Int. Cl. G06F 3/048; G06F 3/01; G06F 17/00; G06Q 30/00

(52) U.S. Cl. 715/205; 715/781; 715/716; 705/14.64

(57) ABSTRACT

An advertising application is provided that can be used on a mobile device to impose screen control restrictions on a portion of the mobile device display, in order to provide a controllable mechanism for displaying advertising content. The advertising application causes the display screen to be split into two or more portions, with an advertising application display having limited screen control so that advertising content can be played according to a schedule or at event driven times as dictated by an administrator or other entity so that the mobile device's services may be subsidized in part by the advertising content providers. The advertising display runs independent of the normal, user initiated applications and does not need to consider screen placement within the normally running applications and is not dependent on when the user decides to close down an application.

This application claims priority from U.S. provisional application No. 61/087,029 filed on Aug. 7, 2008, the contents of which are incorporated herein by reference.

### TECHNICAL FIELD

The following relates generally to mobile telecommunications, and more particularly, to systems and methods for providing content on a mobile device by controlling an application independent of user action.

### DESCRIPTION OF THE RELATED ART

Advertising, both direct advertising and that which is associated with a provided service (e.g. brought to you by Company X) may be used as a way to offset the cost of providing such a service, e.g. wherein the advertiser pays for all or part of the service in exchange for a venue to present advertising content to one or more users. Advertising may only be effective if the user is interested in the content and can become a nuisance if the user is overwhelmed with too much content, or content that may be deemed inappropriate or irrelevant.

Accordingly, the way in which advertising content is gathered and distributed is generally done with the end user in mind. When advertising through television, radio and the Internet, advertising content is traditionally directed to what the likely audience would be for the delivered content. This can be a useful way for advertisers to be confident that they are advertising in the most appropriate venue, at least in a general sense, but may only work when broadcasting according to a schedule or associating the advertising content with a particular medium such as a website that has a specific purpose or target audience.

On a mobile device, although the user may have access to such broadcasted content and may be able to access particular media, various other uses of the mobile device may command the user's attention at various times during a given day. As such, advertising on a mobile device can be more challenging than simply associating generic advertising content with a given medium.

### BRIEF DESCRIPTION OF THE DRAWINGS

Embodiments will now be described by way of example only with reference to the appended drawings wherein:

FIG. 1 is a block diagram illustrating an exemplary environment in which data items are pushed from a host system to a mobile device.

FIG. 2 is a block diagram of an exemplary embodiment of a mobile device.

FIG. 3 is a block diagram illustrating exemplary other software applications and components shown in FIG. 2.

FIG. 4 is a system diagram of one configuration for a location estimator that provides location data to a location based service (LBS) and receives LBS content from the LBS in accordance with one embodiment.

FIG. 5 is a system diagram of another configuration for a location estimator that provides location data to an LBS and receives LBS content from the LBS in accordance with one embodiment.

FIG. 6 is a system diagram of yet another configuration for a location estimator that provides location data to an LBS and receives LBS content from the LBS in accordance with one embodiment.

FIG. 7 is a flow diagram showing the retrieval of data by the location estimator for generating the location data in accordance with one embodiment.

FIG. 8 is a flow diagram illustrating a method for applying a hierarchical location estimation of location for generating the location data in accordance with one embodiment.

FIG. 9 is a screen shot showing an exemplary user interface (UI) for a user location profile.

FIG. 10 is a screen shot showing an exemplary user interface (UI) for a user advertising profile.

FIG. 11 is a flow diagram illustrating a method for estimating the physical location of a mobile device according to user input data.

FIG. 12 is a block diagram illustrating one configuration for providing location data and profile data to an advertising content server and receiving advertising content to be displayed in an advertising application in accordance with one embodiment.

FIG. 13 is a system diagram illustrating another configuration for providing location data and profile data to an advertising content server and generating advertising content to be displayed in an advertising application.

FIGS. 14(a) to 14(c) are screen shots illustrating the persistence of the advertising application during a change of user-controlled applications.

FIGS. 15(a) and 15(b) are screen shots similar to FIGS. 14(a) to 14(c) showing the persistence of the advertising application following use of a phone application.

FIGS. 16(a) to 16(c) are screen shots illustrating one example of a click-through operation initiated through the advertising operation.

FIG. 17 is a flow diagram illustrating a method for updating advertising content from the advertising content server and storing the advertising content in an advertising content cache.

FIG. 18 is a flow diagram illustrating a method for running the advertising application according to a specified schedule.

FIG. 19 is a flow diagram illustrating a method for disabling the advertising application during operation thereof according to specific events.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It has been recognized that by imposing certain restrictions on the screen control of a application display running separately and distinctly from normally running applications, better control over the delivery of multimedia content (e.g. advertising content) on a mobile device can be achieved. As will be discussed herein, a multimedia application, exemplified herein as an advertising application, can be used on the mobile device to impose screen control restrictions on a portion of the mobile device display, in order to provide a controllable mechanism for displaying advertising content. The advertising application causes the display screen to be split into two or more portions, with an advertising application display having limited screen control so that advertising content can be played according to a schedule or at event driven times as dictated by an administrator or other entity so that the mobile device's services may be subsidized in part by the advertising content providers. The limited screen control associated with the advertising application display enables the advertising application to control how long and in what circumstances the advertising content is displayed such that the advertising application display may persist on the display regardless of which applications are running on the remainder of the display. In this way, the advertising display may run independent of the normal, user initiated applications and thus may not need to consider screen placement within the normally running applications and may not be dependent on when the user decides to close down or switch between applications. In systems such as those that continuously push information to a mobile device, the advertising application can be controlled seamlessly using an advertising content server that is integrated with a host system or intermediary router with inherent anonymity to protect the user's privacy, in particular regarding location and preferences.

It has also been recognized that the location of a mobile device and its user, both physically and according to user preferences, can be more intelligently estimated using a multi-level hierarchy that includes not only available device-tracking mechanisms but also user input. As will also be described, the portal application and any other location based service (LBS) can be used with a location estimator to narrow and categorize the advertising content at least in part based on location, either physical location or preferred location or both. The location estimator can therefore improve the filtering of the advertising content and the portal application illustrates one example of an application making use of an LBS. The different configurations described herein are for illustrative purposes only and it will be appreciated that variations of these configurations can be made while utilizing the principles discussed herein.

Examples of applicable communication devices include without limitation pagers, cellular phones, satellite phones, smart-phones, wireless organizers, personal digital assistants, computers, laptops, handheld wireless communication devices, wirelessly enabled notebook computers, wireless media players, wireless navigation devices, wireless heart or exercise monitors, and the like. Such devices will hereinafter be commonly referred to as “mobile devices” for ease of illustration.

An exemplary mobile device generally comprises a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

The mobile device may be one that is used in a system that is configured for continuously routing all forms of pushed information from a host system to the mobile device. One example of such a system will now be described.

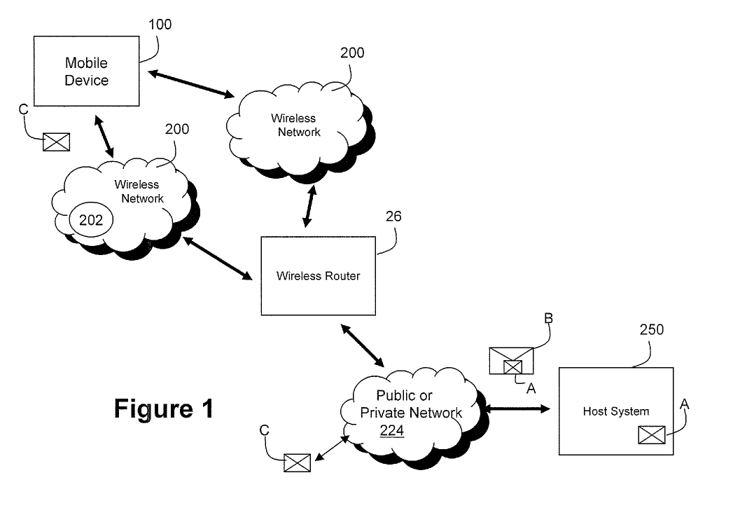

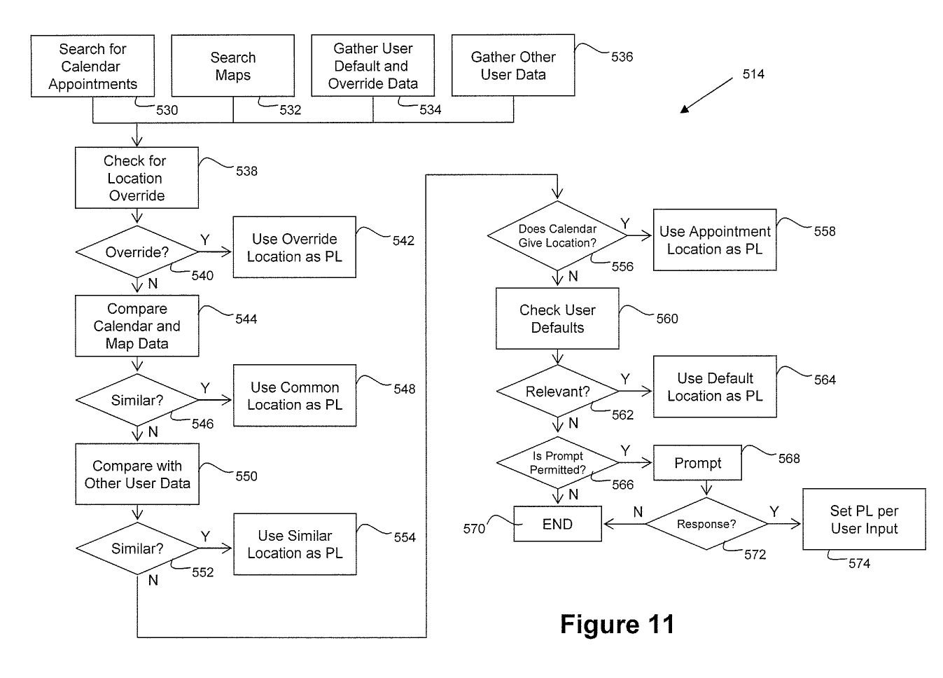

Referring now to the drawings, FIG. 1 is a block diagram showing an exemplary system for the redirection of user data items (such as message A or C) from a corporate enterprise computer system (host system) 250 to the user's mobile device 100 via a wireless router 26. The wireless router 26 provides the wireless connectivity functionality as it acts to both abstract most of the wireless network's 200 complexities, and it also implements features to support pushing data to the mobile device 100. Although not shown, a plurality of mobile devices may access data from the host system 250. In this example, message A in FIG. 1 represents an internal message sent from, e.g. a desktop computer 262 within the host system 250 (see FIG. 11), to any number of server computers in the corporate network 260 (e.g. LAN), which may, in general, comprise a database server, a calendar server, an E-mail server or a voice-mail server. More detail concerning the host system 250 will be provided below and is shown in FIG. 11.

Message C in FIG. 1 represents an external message from a sender that is not directly connected to the host system 250, such as the user's mobile device 100, some other user's mobile device (not shown), or any user device connected to the public or private network 224 (e.g. the Internet). Message C could be e-mail, voice-mail, calendar information, database updates, web-page updates or could even represent a command message from the user's mobile device 100 to the host system 250. The host system 250 may comprise, along with the typical communication links, hardware and software associated with a corporate enterprise computer network system, one or more wireless mobility agents, a TCP/IP connection, a collection of datastores, (for example a data store for e-mail could be an off-the-shelf mail server like Microsoft Exchange® Server or Lotus Notes® Server), all within and behind a corporate firewall as will be explained further below.

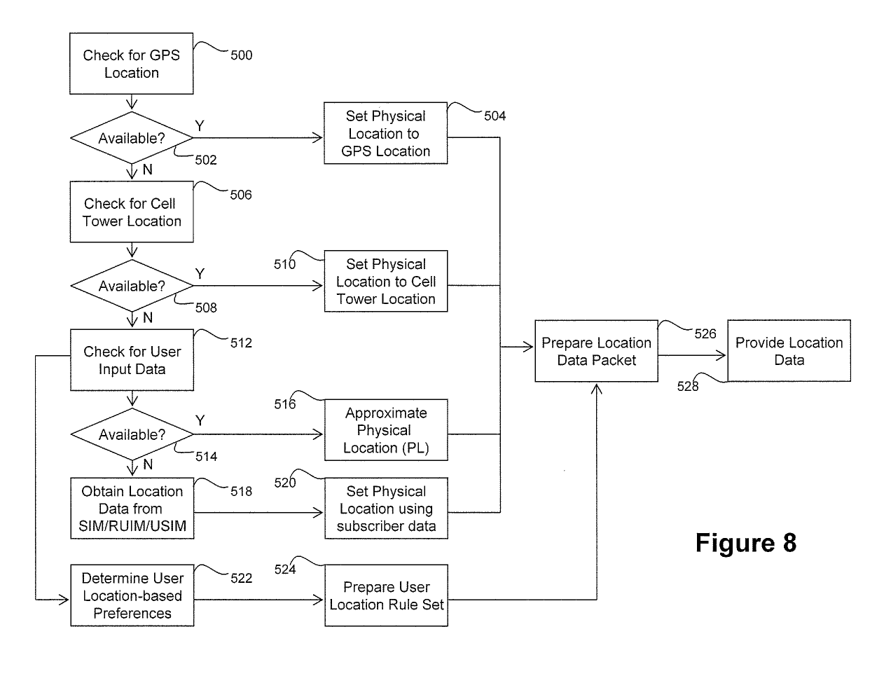

The mobile device 100 may be adapted for communication within wireless network 200 via wireless links, as required by each wireless network 200 being used. As an illustrative example of the operation for a wireless router 26 shown in FIG. 1, consider a data item A, repackaged in outer envelope B (the packaged data item A now referred to as “data item (A)”) and sent to the mobile device 100 from an Application Service Provider (ASP) in the host system 250. Within the ASP is a computer program, similar to a wireless mobility agent, running on any computer in the ASP's environment that is sending requested data items from a data store to a mobile device 100. The mobile-destined data item (A) is routed through the network 224, and through the wireless router's 26 firewall 27 protecting the wireless router 26 (see also FIG. 8).

Although the above describes the host system 250 as being used within a corporate enterprise network environment, this is just one embodiment of one type of host service that offers push-based messages for a handheld wireless device that is capable of notifying and presenting the data to the user in real-time at the mobile device when data arrives at the host system.

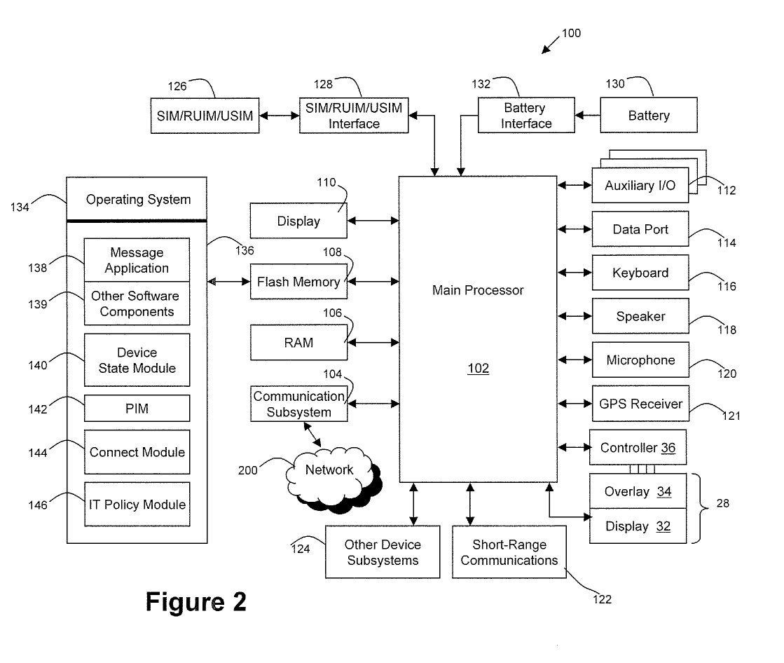

By offering a wireless router 26, there may be a number of advantages to both the host system 250 and the wireless network 200 in accordance with various embodiments. The host system 250 in general runs a host service that is considered to be any computer program that is running on one or more computer systems. The host service is said to be running on a host system 250, and one host system 250 can support any number of host services. A host service may or may not be aware of the fact that information is being channelled to mobile devices 100. For example an e-mail or message program 138 (see FIG. 2) might be receiving and processing e-mail while an associated program (e.g. an e-mail wireless mobility agent) is also monitoring the mailbox for the user and forwarding or pushing the same e-mail to a wireless device 100. A host service might also be modified to prepare and exchange information with mobile devices 100 via the wireless router 26, like customer relationship management software. In a third example, there might be a common access to a range of host services. For example a mobility agent might offer a Wireless Access Protocol (WAP) connection to several databases.

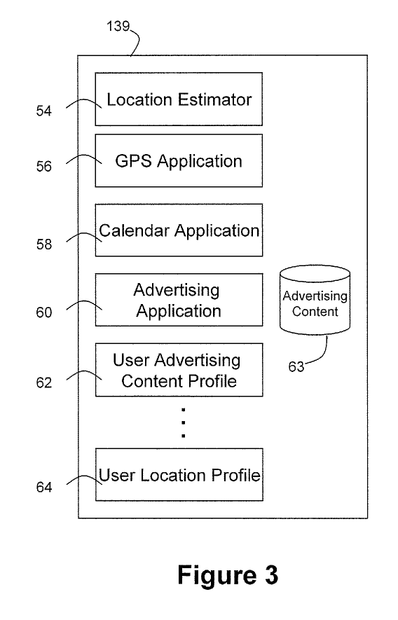

As discussed above, a mobile device 100 may be a handheld two-way wireless paging computer as exemplified in FIGS. 2-3, a wirelessly enabled palm-top computer, a mobile telephone with data messaging capabilities, a PDA with mobile phone capabilities, a wirelessly enabled laptop computer, a vending machine with an associated OEM radio modem, a wirelessly-enabled heart-monitoring system or, alternatively, it could be other types of mobile data communication devices capable of sending and receiving messages via a network connection. Although the system is exemplified as operating in a two-way communications mode, certain aspects of the system could be used in a “one and one-half” or acknowledgment paging environment, or even with a one-way paging system. In such limited data messaging environments, the wireless router 26 still could abstract the mobile device 100 and wireless network 200, offer push services to standard web-based server systems and allow a host service in a host system 250 to reach the mobile device 100 in many countries.

The host system 250 shown herein has many methods when establishing a communication link to the wireless router 26. For one skilled in the art of data communications the host system 250 could use connection protocols like TCP/IP, X.25, Frame Relay, ISDN, ATM or many other protocols to establish a point-to-point connection. Over this connection there are several tunneling methods available to package and send the data, some of these include: HTTP/HTML, HTTP/XML, HTTP/Proprietary, FTP, SMTP or some other proprietary data exchange protocol. The type of host systems 250 that might employ the wireless router 26 to perform push could include: field service applications, e-mail services, stock quote services, banking services, stock trading services, field sales applications, advertising messages and many others. This wireless network 200 abstraction is made possible by the wireless router 26, which implements this routing and push functionality. The type of user-selected data items being exchanged by the host could include: E-mail messages, calendar events, meeting notifications, address entries, journal entries, personal alerts, alarms, warnings, stock quotes, news bulletins, bank account transactions, field service updates, stock trades, heart-monitoring information, vending machine stock levels, meter reading data, GPS data, etc., but could, alternatively, include any other type of message that is transmitted to the host system 250, or that the host system 250 acquires through the use of intelligent agents, such as data that is received after the host system 250 initiates a search of a database or a website or a bulletin board.

The wireless router 26 provides a range of services to make creating a push-based host service possible. These networks may comprise: CDMA (Code Division Multiple Access) networks, GSM (Groupe Special Mobile or the Global System for Mobile Communications) networks, GPRS (General Packet Radio Service)networks, and third-generation (3G) and fourth-generation (4G) networks including without limitation EDGE (Enhanced Data rates for GSM Evolution), UMTS (Universal Mobile Telecommunications System), HSDPA (High-Speed Downlink Packet Access), LTE (Long Term Evolution), WiMAX (Worldwide Interoperability for Microwave Access), etc. Some older examples of data-centric networks include, but are not limited to: the Mobitex Radio Network (“Mobitex”) and the DataTAC Radio Network (“DataTAC”).

To be effective in providing push services for host systems 250, the wireless router 26 may implement a set of defined functions. It can be appreciated that one could select many different hardware configurations for the wireless router 26, however, many of the same or similar set of features would likely be present in the different configurations. The wireless router 26 may offer any one or more of the following features for host services: 1) An addressing method so that mobile device 100 traffic can be addressed to a host system 250 without the need for the wireless network 200 to assign an identity to each host system 250; 2) An efficient and authenticated method for the host system 250 to initiate a communication connection to the wireless router 26 for the purposes of opening a communication tunnel to the one or more mobile devices 100 that the host system 250 wishes to communicate with; 3) A reliable method for exchanging data between the host system 250 and the mobile device 100, in a manner consistent with the abilities of the wireless network 200; 4) Providing feedback to the host system 250 when data is delivered, which allows the host system to clean up any wireless delivery queues if necessary, or inform the original sender (user or program) that the data has been delivered to the mobile device 100; 5) Implementation of a wireless network 200 initiated push of services or data to a mobile device 100, from a wireless router 26; and 6) Connecting to a wide range of wireless networks 200 and provide a way of tracking the user's location so that a “follow you anywhere” solution can be provided.

To aid the reader in understanding the structure of the mobile device 100 and how it communicates with the wireless network 200, reference will now be made to FIGS. 2 through 3.

Referring first to FIG. 2, shown therein is a block diagram of an exemplary embodiment of a mobile device 100. The mobile device 100 comprises a number of components such as a main processor 102 that controls the overall operation of the mobile device 100. Communication functions, including data and voice communications, are performed through a communication subsystem 104. The communication subsystem 104 receives messages from and sends messages to a wireless network 200. In this exemplary embodiment of the mobile device 100, the communication subsystem 104 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, a GPS receiver 121, short-range communications 122, and other device subsystems 124.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 200 after required network registration or activation procedures have been completed. Network access is associated with a subscriber or user of the mobile device 100. To identify a subscriber, the mobile device 100 may use a subscriber module component or “smart card” 126, such as a Subscriber Identity Module (SIM), a Removable User Identity Module (RUIM) and a Universal Subscriber Identity Module (USIM). In the example shown, a SIM/RUIM/USIM 126 is to be inserted into a SIM/RUIM/USIM interface 128 in order to communicate with a network. Without the component 126, the mobile device 100 is not fully operational for communication with the wireless network 200. Once the SIM/RUIM/USIM 126 is inserted into the SIM/RUIM/USIM interface 128, it is coupled to the main processor 102.

The mobile device 100 is a battery-powered device and includes a battery interface 132 for receiving one or more rechargeable batteries 130. In at least some embodiments, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 100 during its manufacture. Software applications may include a message application 138, a device state module 140, a Personal Information Manager (PIM) 142, a connect module 144 and an IT policy module 146. A message application 138 can be any suitable software program that allows a user of the mobile device 100 to send and receive electronic messages, wherein messages are typically stored in the flash memory 108 of the mobile device 100. A device state module 140 provides persistence, i.e. the device state module 140 ensures that important device data is stored in persistent memory, such as the flash memory 108, so that the data is not lost when the mobile device 100 is turned off or loses power. A PIM 142 includes functionality for organizing and managing data items of interest to the user, such as, but not limited to, e-mail, text messages, instant messages, contacts, calendar events, and voice mails, and may interact with the wireless network 200. A connect module 144 implements the communication protocols that are required for the mobile device 100 to communicate with the wireless infrastructure and any host system 250, such as an enterprise system, that the mobile device 100 is authorized to interface with. An IT policy module 146 receives IT policy data that encodes the IT policy, and may be responsible for organizing and securing rules such as the “Set Maximum Password Attempts” IT policy.

Other types of software applications or components 139 can also be installed on the mobile device 100. These software applications 139 can be pre-installed applications (i.e. other than message application 138) or third party applications, which are added after the manufacture of the mobile device 100. Examples of third party applications include games, calculators, utilities, etc.

The additional applications 139 can be loaded onto the mobile device 100 through at least one of the wireless network 200, the auxiliary I/O subsystem 112, the data port 114, the short-range communications subsystem 122, or any other suitable device subsystem 124.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

For composing data items, such as e-mail messages, for example, a user or subscriber could use a the touch-sensitive overlay 34 on the display 32 that are part of the touch screen display 28, in addition to possibly the auxiliary I/O subsystem 122. The auxiliary I/O subsystem 112 may include devices such as: a mouse, track ball, infrared fingerprint detector, or a roller wheel with dynamic button pressing capability. A composed item may be transmitted over the wireless network 200 through the communication subsystem 104.

FIG. 3 shows an example of some of the other software applications and components 139 that may be stored and used on the mobile device 100. Only a few representative examples are shown in FIG. 3 for illustrative purposes, and such examples are not to be considered exhaustive. In this example, the mobile device 100 includes, stores and operates a location estimator 54 for gathering and determining location data pertaining to the mobile device 100, the GPS application 56 for obtaining GPS coordinates from the GPS receiver 121 for use with an LBS or on-device mapping functions etc and a calendar application 58 for storing appointments and contacts etc. The other applications 139 also include, in this example, an advertising application 60, which, as will be described in greater detail below, runs in parallel to a currently running program on the mobile device 100 and provides minimal or no screen control to the user while providing advertising and multimedia content to the user at specified times. The advertising application 60 has access to an advertising content data store 63, which stores one or more sets of cached advertising and multimedia content that is displayed to the user through the advertising application 60.

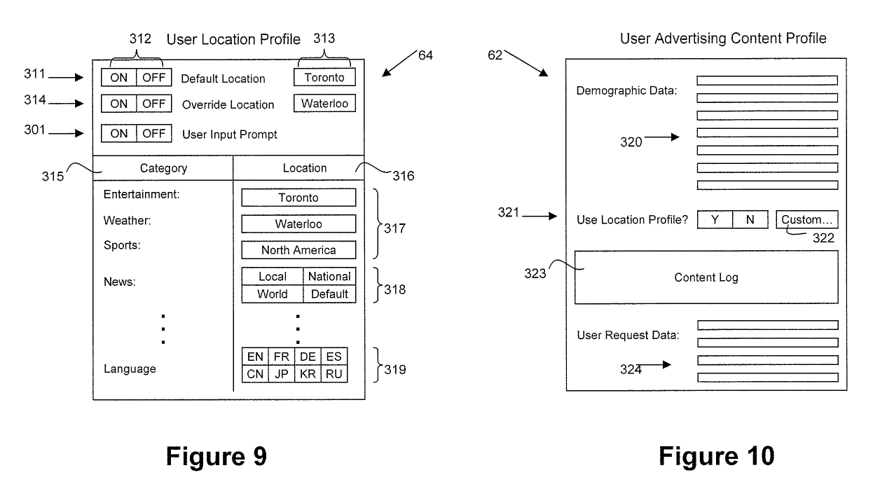

Also shown in FIG. 3 is a user advertising content profile 62 and a user location profile 64. The advertising content profile 62, which will be shown and explained in greater detail with reference to FIG. 10, contains user selected information to assist the advertising application 60 in determining what content should be provided to the user and when. As will be explained below, the advertising content profile 62 contains information such as demographic and user-specified requests for certain content, and can be linked to the location profile 62. The advertising content profile 62 can be used to filter advertising content either before it enters the cache 63 (i.e. at some intermediary) or on the mobile device 100 before it is displayed through the advertising application 60. As such, the advertising content cache 63 can include pre-filtered content or user-specific content depending on whether the advertising content is processed for the user at such an intermediary or on the mobile device 100. Examples are provided below illustrating variations in such filtering. The location profile 64 contains user-specified information to assist in making location-based decisions for matching advertising content to a particular user, i.e. to provide context. As will be discussed below and as shown in FIG. 9, the location profile 64 contains a user's location-based preferences that relate to both physical location (of the mobile device 100) and preferred location, i.e. locations that may be different than the actual location of the mobile device 100.

Location based services (LBS) 298 for the mobile device 100 are naturally dependent on knowledge of the location of the mobile device 100 in order to determine appropriate, location-based content for the user of the mobile device 100, in particular where the content is location dependent or would otherwise be more relevant if filtered based on physical location or user location-based preferences or both.

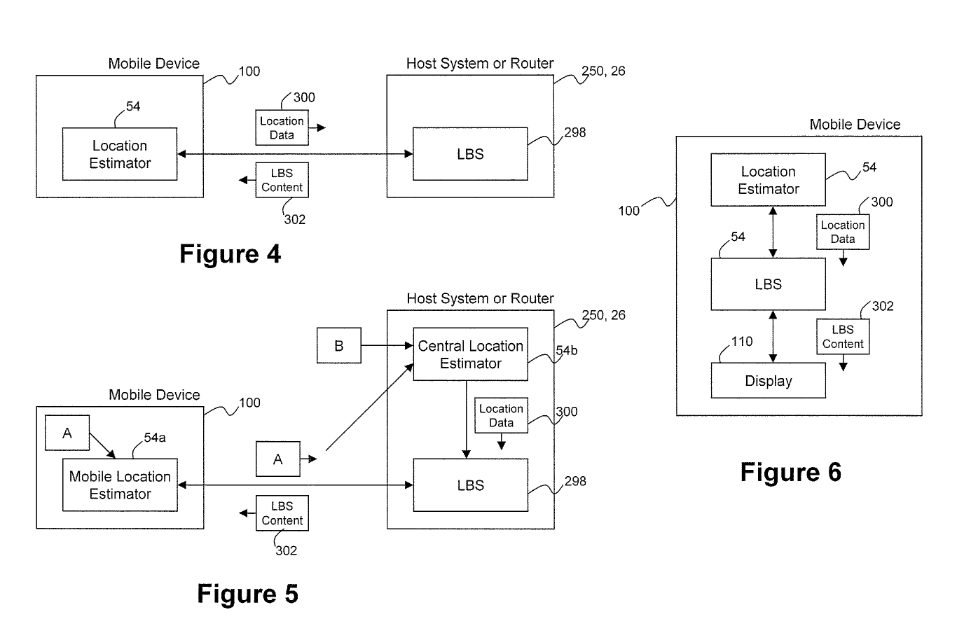

Turning now to FIGS. 4 to 6, various configurations are shown for providing location data 300 to an LBS 298 in order to obtain or receive user-specific content, herein referred to as LBS content 302. The systems shown in FIGS. 4 to 6 are utilized to localize information such as weather, news, local events, etc. according to a location hierarchy of: 1) GPS location; 2) Current cell tower location; 3) User Input or Preferences; and 4) Data available from the SIM/RUIM/USIM card 126 (e.g. area code or postal code). This hierarchy can be used alone to provide location data that relates only to the physical location of the mobile device 100 or along with user-input related location data. Such user-input related location data can be used for filtering certain LBS content 302 such as advertisements for a user based on locations specified by user preferences (e.g. as specified in the user location profile 64) rather than or in addition to the physical location of the mobile device 100. In this way, for example, a user can receive news from their home city even when travelling. Although the systems shown in FIGS. 4 to 6 include simplified block diagrams showing only certain ones of the components involved in generating location data 300 and LBS content 302, it will be appreciated that these configurations can be implemented with the systems and operations thereof as described above as well as other similar systems.

In general, a method is provided for estimating the location of a mobile device comprising determining if global positioning coordinates are available and if so, estimating the location using the global positioning coordinates; if the global positioning coordinates are not available, determining if one or more cell tower locations are available and if so, estimating the location using the one or more cell tower locations; if the global positioning coordinates and the one or more cell tower locations are not available, determining if user input indicative of a current location of the mobile device is available and if so, estimating the location using the user input; and if the global positioning coordinates, the one or more cell tower locations and the user input is unavailable, obtaining location-based data according to a subscriber identity device and estimating the location using the location-based data.

Referring now to FIG. 4, one configuration comprises having the location estimator 54 reside solely on the mobile device 100 with the LBS 298 at an intermediate node or intermediary such as the host system 250 or router 26 described above. It will be appreciated that the host system 250 and router 26 are shown only for illustrative purposes and for ease of explanation and other intermediaries such as ISPs, third party web servers and the like may also perform this role. This configuration divides the processing tasks associated with the location estimation and filtering processes between the mobile device 100 and the host system 250 or router 26. In this way, the mobile device 100 runs the location estimator 54 to provide to the LBS 298 the location data 300 available to the mobile device 100 and, in return, the LBS 298 filters and provides location-specific LBS content 302 to the mobile device 100. The LBS content 302 can be used in many different applications on the mobile device 100 such as for providing user-specific advertising content to the user as will be exemplified below.

FIG. 5 shows another configuration that divides the processing requirements between the mobile device 100 and the intermediary—i.e. the host system 250 or router 26 in this example. In this configuration, portion A of the location data 300 is determined or otherwise acquired at the mobile device 100 by a mobile location estimator 54a and sent to a central location estimator 54b at the intermediary. Portion A is combined with portion B of the location data 300 to generate the complete set of location data 300, which is processed by the LBS 298 as in the above configuration to generate the LBS content 302. This configuration is most suitable where certain location information is more conveniently accessed by the mobile device 100 whereas other location information is more conveniently or efficiently accessed at the intermediary. For example, the GPS location may be acquired on the mobile device 100 and sent to the host system 250 or router 26 which stores and updates the user location profile 64.

Referring now to FIG. 6, one example is shown where all of the location estimation tasks are handled by one entity, in this example the mobile device 100. It will be appreciated that a similar configuration wherein all components reside at the intermediary may also be used. It can be seen in FIG. 6 that the location estimator 54 generates the location data 300 in a manner similar to the configuration of FIG. 4, however, in this configuration, the LBS 298 resides on the mobile device 100 and thus the LBS content 302 can be generated locally and used in connection with a program or application without relying on a connection with the intermediary at all times. In the example shown, the LBS content 302 is provided to the display 110 component of the mobile device 100 that operates the physical display 12.

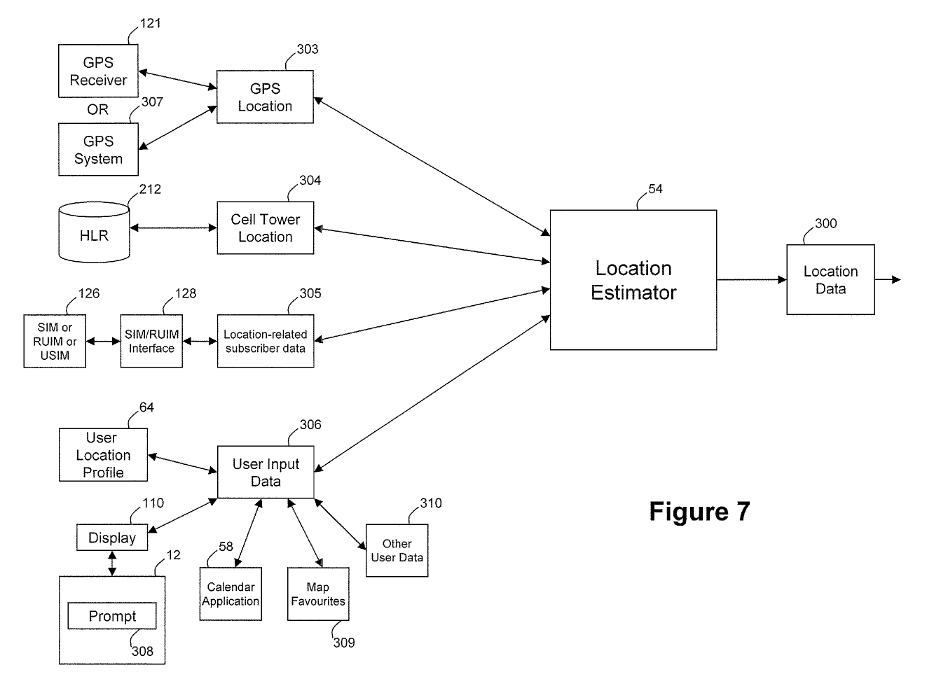

FIG. 7 illustrates an example of the flow of data to the location estimator 54 for generating the location data 300. In this example, the location estimator 54 utilizes GPS location 303, cell tower location 304, location-related SIM data 305 and user input data 306 according to a hierarchy as described in greater detail below (see also FIG. 8). The GPS location 303, depending on whether this data is acquired by the mobile device 100 or the intermediary (host system 250 or router 26 in this embodiment), is acquired from either the GPS receiver 121 (on the mobile device 100) or directly from an associated GPS system 307 (at the intermediary) if available. The cell tower location 304 can be obtained directly from an HLR 212 of the wireless network 200, in particular from a specific node 202 (details provided above) or any other network component that is capable of determining or having access to the location of the mobile device 100 with respect to a certain one or ones of the cell towers in the wireless network 200. It will be appreciated that other techniques for obtaining location may be used in various embodiments such as without limitation, obtaining information from the VLR 214, or triangulation using at least three tower stations, or other suitable techniques. The location-related subscriber data 305 is obtained from the SIM/RUIM/USIM card 126 through the SIM/RUIM/USIM interface 128 and may include any location-specific information stored in the SIM/RUIM/USIM card 126. This may include the area code of the mobile device's phone number, a postal code or other address information or even calendar appointments that are sometimes stored temporarily on the SIM/RUIM/USIM card 126.

As can be seen in FIG. 7, the user input data 306 can come from various different locations and processes. The examples shown in FIG. 7 include the user location profile 64, a prompt 308 through the display 12 and display component 110, the calendar application 58, map favorites 309 and other user data 310. The prompt 308 can be an optional mechanism for obtaining user input when other relevant data cannot be found or if the user chooses to actively participate in specifying their location. The prompt 308 can include a dialog box with an entry portion to enable the user to enter their current location if prompted. The calendar application 58 can provide appointment details such as location of a meeting. The map favorites 309 illustrates one way of obtaining relevant user data indirectly. For example, users often use a map application (not shown) on their mobile device 100 to find directions to a specific location. Depending on how long it has been since the map application has been used, the map data that was last accessed or as shown in FIG. 7, map data that is included as a favorite may be useful in determining a relevant location. The other user data 310 can be from any application or service for the mobile device 100 that can provide an indication, however insignificant, of where the user may be, may wish to be, has been etc.

The user location profile 64 is shown in greater detail in FIG. 9. As noted above, the user location profile 64 enables a user to specify location-based preferences so that LBS content 302 such as advertisements, weather, news, etc. can be tailored to their lifestyle. Since a user's physical location may not necessarily correspond to the relevant location for the user, the user location profile 64 allows the user to customize content for relevance. For example, although the user's physical location is typically relevant for weather information, a user may prefer to receive news articles that are local to where they live or work, regardless of their physical location. Another example pertains to language. A user travelling in Europe may presently be in France but live in Germany and thus wish to receive only German-language advertisements, news and other content even when currently in France. Turning now to FIG. 9, several examples of suitable user preference options are shown. In this example, the user can select and distinguish between a default location 311 and an override location 314. The default location 311 can be used to specify a location to be associated with the user if no other information is available. The override location can be used to override other mechanisms for estimating physical location and other preferences. An example of a use for the default location 311 would be for the user to specify their home city or where they work, i.e. a place where they spend a significant amount of time and thus sporting events, concert tickets and other promotions would likely be of interest to them. An example of a use for the override location 314 would enable a user to override more relevant information and direct it to the specified city. In this way, a user that is travelling may wish to only receive weather reports for their home city even though they are experiencing different weather in their physical location. Any other motivation can form the basis for specifying an override or default at the user's discretion. As can be seen, when displayed in a user interface (UI), the location profile 64 can include ON/OFF toggle buttons 312 to enable the user to turn the associated feature on or off as well as input boxes 313 to specify the desired location. As also shown in FIG. 9, the user can specify whether or not they may be prompted to provide their location by turning a user input prompt option 301 to be “ON” or “OFF”.

The user location profile 64 can also allow the user to specify a location 316 for a number of different categories 315. The examples given in FIG. 9 include entertainment, weather, sports, news and language categories 315 and illustrates several input mechanisms to allow the user to conveniently set and modify their preferences. These include input boxes 317, multi-choice buttons 318 with different regional preferences, and multi-choice buttons 319 showing available languages. It will be appreciated that the categories 315 and selection mechanisms 312, 313, 317, 318, 319 shown in FIG. 9 are for illustrative purposes only and that any suitable UI components can also be used in addition to or rather than those shown. In general, the location profile 64 allows the LBS 298 to filter the available content to provide a more relevant set of LBS content 302 to a specific user. It can be seen that user selected preferences can be used to improve the relevance of the LBS content 302 for that user.

Having access to location-based information such as the GPS location 303, cell tower location 304, user input data 306 and location related subscriber data 305, the location estimator 54 can use a hierarchical approach for generating the location data 300. In one embodiment, the location estimator 54 applies a hierarchy to estimate a physical location (PL) for the mobile device 100 so that the LBS 298 can associate relevant content with that particular mobile device 100. In another embodiment, the location estimator 54 applies the hierarchy to estimate the PL while in parallel using the user input data 306 to provide additional context for the LBS 298. This allows the LBS 298 to associate some content with physical location and other content with user-specified locations. For example, the LBS 298 may provide weather data that is relevant to the user's surroundings and sports scores relevant to home teams, preferred leagues etc. As noted above and shown in FIGS. 4-6, the location estimator 54 can operate in the mobile device 100, in an intermediary or both. The LBS 298 can also operate in the mobile device 100, in an intermediary or both. The following examples apply to any one of these configurations.

FIG. 8 illustrates one example of a series of computer readable instructions performed by the location estimator 54 to generate the location data 300. This example applies the following hierarchy for estimating the PL: 1) GPS location; 2) Cell tower location; 3) User input data and other user related information; and 4) Subscriber location-based data. Following this hierarchy, if the GPS location is not available, the cell tower location can be used. If the cell tower location is also unavailable, the user input and other information can be used, e.g. without limitation a calendar appointment, location profile, geotagging data associated with a web site, blog, RSS feed, or photograph, etc., (e.g., data uploaded by the mobile device 100 to a web site such as Twitter™, Facebook™, or Flickr™, etc.). If no relevant user data can be found, data on the SIM/RUIM/USIM card 126 can be used. At 500, the location estimator 54 checks the GPS receiver 121 or GPS system 307 for any available GPS coordinates. Tolerances can be specified such as how current are the coordinates. At 502, if the GPS coordinates are available and relevant, the location estimator 54 sets the PL to be equal to the GPS location at 504. If the GPS coordinates are not available or are out-of-date, the next level in the hierarchy, namely the cell tower location 304 is investigated at 506. At 508, if the cell tower location 304 is available, e.g. from the HLR 212, then the PL is set to be a region or area associated with or close to the specified cell tower at 510. If the cell tower location 304 is not available or otherwise not relevant, the next level in the hierarchy is examined, namely the user input data 306 at 512. If relevant user input data 306 is deemed to be available at 514, the most relevant of such available user input data 306 is used by the location estimator 54 to provide an approximate PL at 516. Further details of such an approximation are explained in greater detail below making reference to FIG. 11. If the user input data 306 is not available or cannot be deemed acceptable or relevant, the location estimator 54 instructs the processor 102 to access data from the SIM/RUIM/USIM card 126 through the SIM/RUIM/USIM interface 128 at 518. Since the SIM/RUIM/USIM card 126 stores at least the phone number for the mobile device 100, it will have at the very least an area code that can be used to specify the PL. It can be appreciated that by virtue of the mobile device 100 being “mobile”, the area code is typically not as relevant as, e.g. the GPS coordinates; however does ensure that a location can be specified. The SIM/RUIM/USIM card 126 may also store other information such as an address and postal code, recent calendar appointments and other data that can provide evidence of a relevant location. Therefore it may be appreciated that the location-based subscriber data 305 may comprise any available data and should not be limited to area code only. If the hierarchy proceeds to this level, then the most relevant location-based subscriber data 305 is used to set the PL at 520.

As can be seen in FIG. 8, in addition to determining PL, the location estimator may, in parallel to applying the hierarchy, determine user location-based preferences at 522 and prepare a user location rule set at 524. This rule set and the PL determined above are combined at 526 to prepare a data 300 packet or other data structure suitable for providing the location data 528 to the LBS 298. The user location-based preferences 522 are determined from the user input data 512, namely in this example as taken from the user location profile 64. The rule set prepared at 524 can specify locations for certain categories and rules for overriding or defaulting certain content to the specified locations. As explained below, the user location-based preferences can also be estimated from other user input data 306 such as appointments extracted from the calendar application 58 and location data extracted from map favourites 309.

As noted above, the location estimator 54 can at one level of the hierarchy, approximate PL according to user input data 306, i.e. when determining if the user input data 306 is available at 514. FIG. 11 illustrates one example for performing such an approximation, using the exemplary user input data 306 shown in FIG. 7. At 530-536, the location estimator 54 first gathers the relevant data, e.g. by having the processor 102 access the calendar application 58, the map program and any other user data. At this time, the location estimator 54 can access the user location profile 64 to determine if any overrides or defaults exist that would assist in performing the location approximation. Then, at 538, the location estimator first determines if there is an override location 314 specified by the user. As discussed above, this can be used to ignore actual PL in favour of a user-specified location. If it is determined at 540 that an override location 314 has been specified (i.e. toggle button 312 is set to “ON” and a location entered at input box 313), the PL is set to the override location 314 at 542. If the user has turned off the override location 314 or this information is otherwise not available, the location estimator 54 may then compare the calendar data to the map data. This may be done to determine if there is any correlation between an appointment and a recently accessed map location. For example, a user when reminded of a meeting may use their map program to find directions. If the calendar and map data are deemed to be similar at 546, the PL is set to be the common location data at 548. If such data is not similar, this may indicate that the most recent location in the map program has nothing to do with a current or recent appointment. It may be noted that if no recent calendar appointments even exist, 544-548 may simply be skipped. If the calendar and map data are not similar, this data may then be compared to the other user data at 550. For example, the other user data 310 may include a memo or note that provides context for an appointment or for a map. If the other data 310 is deemed to be similar or relevant at 552, the similar location is used as the PL at 554. It will be appreciated that in some embodiments, only the calendar data may be referenced without any correlation with other data performed. For example, if an appointment in the user's calendar comprises a location field, which is populated, such location field can be used to determine the mobile device's location, in particular where the meeting is hosted by or has been accepted by the user.

If the calendar, map and other data do not correlate in any way, the location estimator may then use any available location information in the calendar appointment at 556. If a location can be found in the calendar appointment, the PL is then set to be the location specified in the calendar appointment at 558. An example would be a meeting appointment that gives an address for a client or customer site, which can indicate to the location estimator 54 where the user is at that time. It may be noted that the other user data 310 may include an indication as to whether or not the user accepted the appointment in the calendar since appointments that are scheduled but not necessarily accepted may still be posted in the calendar application 58. If the calendar application 58 does not provide any relevant location-based information, the location estimator 54 may then check for a user default location 311 at 560. In this way, the user can specify a default so that if no relevant and current information is available, the location estimator 54 can choose the default location 311 as the PL at 564 to ensure the LBS content 302 is at least directed to an associated and familiar geographical area. If the user default location 311 is not turned “ON” or is not relevant (e.g. misspelled location in input box 313), the location estimator 54 then determines if the user has permitted a prompt 308 to be used at 566, i.e. set the prompt option 301 to “YES”. If a prompt 308 is permitted, the prompt 308 is displayed to the user at 568. The prompt 308 may expire after a specified amount of time so as to not disrupt the PL approximation process in case a user response is not received at 572. If the prompt 308 is not permitted or a response to the prompt 308 is not received in a predetermined amount of time, the PL approximation routine ends at 570. If a response to the prompt 308 is received at 572, the user input acquired from the prompt 308 is used to approximate the PL at 574.

It can be seen from FIGS. 8 and 11 that if the user input data 306 is irrelevant or otherwise not available at 514, the location-based subscriber data 305 is instead used as the PL. As such, the hierarchy enables the location estimator 54 to step through data available to the mobile device 100 (and/or intermediary if applicable) and at any given time give the best estimate possible for ensuring the LBS content 302 is relevant to the user of the mobile device 100.

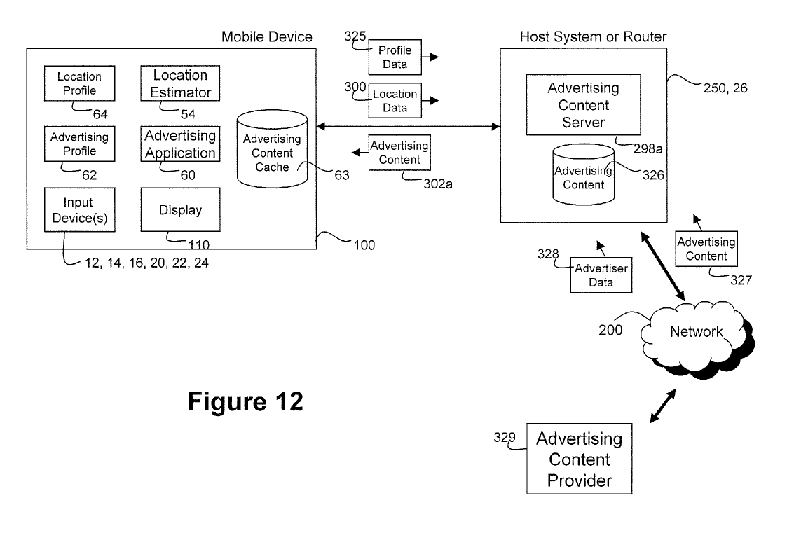

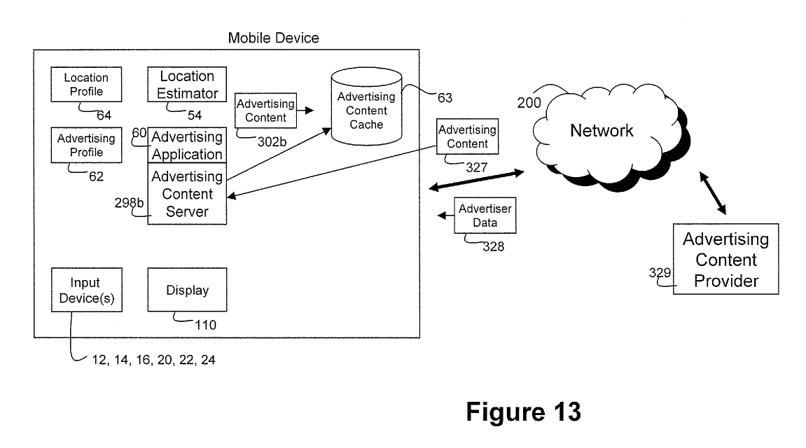

Referring now to FIGS. 10 and 12 to 19, operation of the location estimator 54 will be exemplified when used with the advertising application 60 discussed above. FIGS. 12 and 13 illustrate configurations where the LBS 298 is an advertising content server 298a running on the intermediary (e.g. host system 250 or router 26) and the mobile device 100 (as 298b) respectively. Turning first to FIG. 12, it can be seen that the advertising application 60 resides on the mobile device 100 along with the location estimator 54, similar to the configuration shown in FIG. 4. For the sake of convenience, other relevant mobile device components are shown in FIG. 12 such as the location profile 64, advertising profile 62, advertising content cache 63, input devices (e.g. any one or more of 112, 114, 116, 120, 121, 122) and the display component 110. In this example, the mobile device 100 provides the location data 300 using the location estimator 54, as described above and shown in FIGS. 4-9 and 11; and provides profile data 325 as specified in the advertising profile 62. It will be appreciated that data from the advertising profile 62 may also be transported with the location data 300 and is shown as a separate data packet only for the sake of clarity. The mobile device 100 receives from the host system 250 or router 26, the advertising content 302a that is deemed to be relevant to the user of the mobile device 100, which is stored in the advertising content cache 63 for use by the advertising application 60 at scheduled intervals or upon detecting certain events or conditions as will be explained below.

The advertising content server 298a represents a specific implementation of the LBS 298 shown in FIGS. 4-6 and thus it will be appreciated that the advertising content server 298a may operate according to the principles discussed above. The advertising content server 298a has access to an advertising content data store 326, which typically contains all available (e.g. unfiltered) LBS content 302, including that which is relevant to the user of the mobile device 100 shown in FIG. 12 as well as other users of other mobile devices 100 that are not shown. In other words, the advertising content 326 at the intermediary contains the unfiltered content that is filtered per-user by the advertising content server 298a when generating the advertising content 302a that is sent to the mobile device 100. As can also be seen in FIG. 12, the intermediary obtains advertising content 327 and advertiser data 328 from advertising content providers 329 through the network 200 or any other suitable communication method. It may be noted that “advertising content” (both filtered and original) and “advertiser data” collectively refer to content and details respectively of and from providers of any content that is used by the advertising application 60, including content that is considered to be an advertisement in the traditional sense as well as other multimedia content that may be, e.g., “brought to you by” an advertiser or even paid for by the user, such multimedia content including weather and news content (i.e. not an advertisement in and of itself). The term “advertiser” and “advertisement” is thus used only for the sake of clarity in describing the mechanisms for operating the advertising application 60 as described in detail below. Accordingly, the advertising application 60 may in general be considered a multimedia application that provides a multimedia application display.

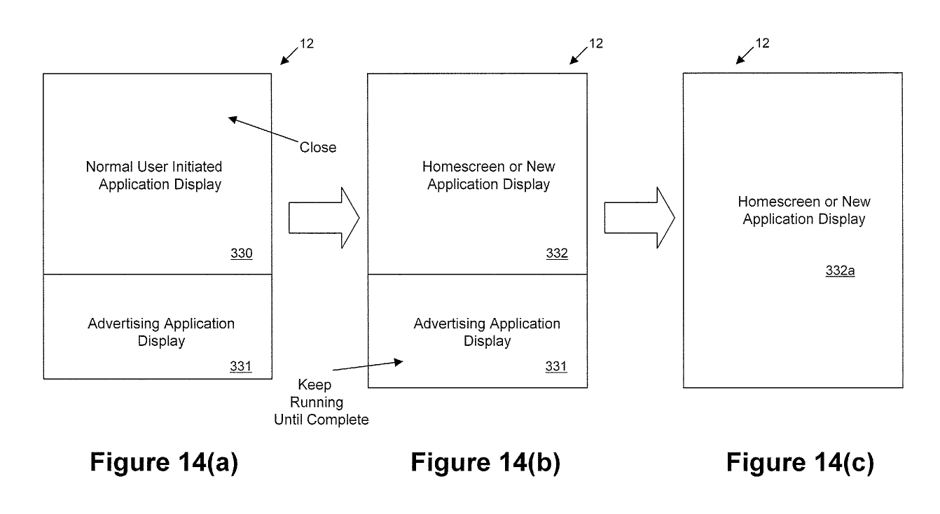

FIG. 13 illustrates a configuration where the mobile device 100 runs a local version of the advertising content server 298b. In this configuration, the advertising content 327 originating from the content provider 329 is sent directly to the mobile version of the advertising content server 298b on the mobile device 100, which is then filtered for relevance, and the advertising content 302b is then stored locally in the advertising content cache 63. It will be appreciated that the advertising content cache 63 can be used to store both unfiltered and filtered advertising content 327 and 302b respectively and the data flow shown in FIG. 13 is merely provided for clarity and understanding. The advertising content 327 can be pushed to the advertising content server 298b by the advertising content provider 329 (which according to the above would utilize the router 26) or can be downloaded (i.e. pulled) by the mobile device 100 at periodic intervals. It will be appreciated that advertising application 60 may operate on the mobile device 100 as exemplified below and shown in FIGS. 14-19 regardless of which configuration is used for obtaining the filtered advertising content 302a or 302b.

Turning now to FIGS. 14(a) to 14(c), a generic screen shot of the mobile device display 12 is shown, when divided during the initiation and persistence of the advertising application display 331. It can be seen that the display 12 is divided into the advertising application display 331 and a normal user initiated application display 330. It may be noted that more than two channels or portions may be used such that a first of the portions contains the advertising application display 331 and a second of the portions contains the normal application display 330. As can be seen in FIGS. 14(a) and 14(b), the display 12 is split into separate display channels wherein the advertising application display 331 is given a separate channel and thus distinct portion of the overall physical display 12 from the normal application display 330. As described in more detail below, the advertising application display 331 is given limited or no user screen control and the display 12 is divided as exemplified in FIG. 14 at specified intervals that is outside of the user's control. Such use of screen control is advantageous for controlling when, how and under what circumstances advertising content is provided to the user, independent of the full interaction capabilities provided for the normal application display 330.

In general, screen control may be considered the extent to which any application or element being displayed on the mobile device 100 can be manipulated, resized, closed, opened or otherwise modified in appearance. There may be device imposed screen control, e.g. during start up where a logo appears but no interactions are permitted, as well as application imposed screen control, e.g. where applications are given certain “real estate” or portions of the display 12 when running together. Also, when the mobile device 100 exercises screen control, this may imply that the user is given less screen control and vice versa. Similarly, when a user is given limited screen control, the mobile device 100 or an application running thereon is retaining most of the control of a particular element or application while the user is able to interact with that element or application in a limited way. As will be discussed below, it has been recognized that different levels of screen control can be given to separate and distinct portions of the display 12 to enable advertising content to be provided to the user under control of the mobile device 100 or an external service.

It may be noted that when combined with some intelligent method of filtering advertising content 327 such that it is user specific, any potential disruptions caused by imposing screen control are mitigated by the nature of the content provided. The examples below include using, in part, the location estimator 54 as described above, for performing such filtering. As such, it will be appreciated that the advertising content server 298a, 298b may be considered an LBS 298 insofar as it considers location when filtering the advertising content 327. Should the advertising content server 298a, 298b not consider location, it may be considered another type of service.

As noted above, the advertising application display 331 may be given a separate and distinct portion of the physical display 12, by operating an independent display channel. In FIG. 14(a), the normal application display 330 is resized to accommodate both displays 330, 331 on the physical screen provided by display 12. If the user closes the normal application display 330 as shown in FIG. 14(a), the normal display portion 330 is refreshed to include either the homescreen 40 or a new application in a still partitioned and separate display 332 as shown in FIG. 14(b). What is to be noted from FIG. 14(b) is that the advertising application display 331 persists on the larger available display 12 and thus is an independent channel that can be maintained for the duration of the advertising playlist or some other period of time before the normal screen control is given back to the new application display 332a as shown in FIG. 14(c). In other words, the advertising application display 331 is configured to run independent of any normal application that is given full screen control and full user interactive abilities thus ensuring that the advertising content 302a is not discarded by simply closing down the current application 330 or switching to another application. This provides an advantage over traditional pop-up advertisements that are initiated and displayed with or in an application and thus only persist as long as the current application 330 is being used. Also, traditional pop-up advertising must consider where in the normal application display 330 to place the advertisement, which is not a problem for the advertising application display 331 shown in FIG. 14(a). This is because the screen control imposed in how the screen 12 is divided ensures that the normal application 330 is only modified in size and not by alteration of its content.

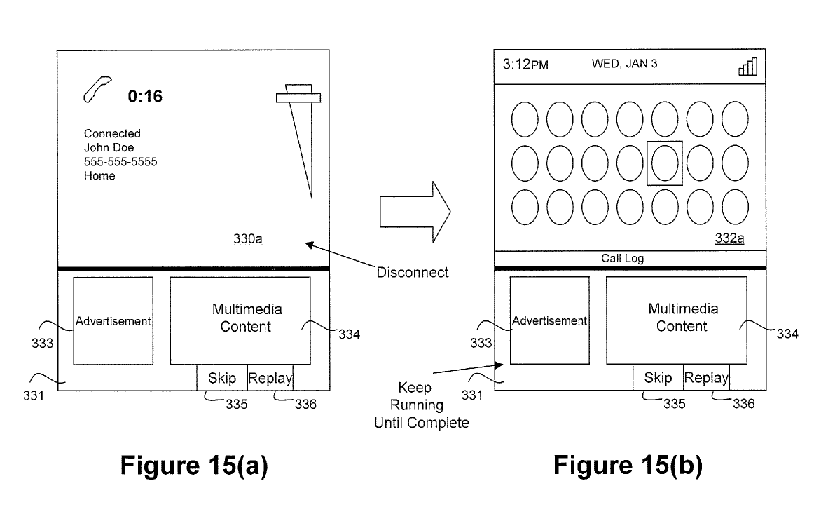

An example of the advertising application display 331 is shown in FIGS. 15(a) and 15(b) when initiated during use of a phone application 330a. As can be seen in FIG. 15(a), the advertising application 331 includes an advertisement 333 and multimedia content 334. The advertisement 333 is shown for illustrative purposes only and to exemplify a case where the multimedia content 334 displays content that is not an advertisement itself but is provided by a particular advertising content provider 329. An example would be latest news stories, weather updates, sports scores, etc. The multimedia content 334 can also be used to show only an advertisement 333 either for a predetermined amount of time or where the advertisement 333 is deemed to be of interest to the user. An example would be top selling games, movie advertisements etc. The advertising application display 331 also includes a Skip control 335 and a Replay control 336. These controls 335, 336 can be provided to give the user some control over whether or not certain content is played and whether or not the content is repeated. However, by imposing limited screen control, the user does not have control over whether or not the advertising content display 331 is displayed, only what is seen during that time period. This arrangement is most suitable for subsidizing the user's service fees through advertising or where an organization owns the mobile device 100 and thus wishes to have control over certain content that is streamed to the user. For example, a company that purchases mobile devices 100 for their employees may use the advertising application display 331 to distribute internal advertisements such as for social functions or to provide reminders, warnings, announcements etc. This further illustrates that “advertising content” can represent any multimedia content that is to be directed at the user, whether or not it is considered a traditional advertisement.

Use of the Skip 335 and Replay 336 controls can also be tracked by the advertising application 60 for usage statistics and to better filter the advertising content 302a in subsequent playlists. For example, if the user repeatedly skips over advertisements for video games, the advertising content cache 63 can be flagged to disregard advertising content 302a that relates to video games. This can also be done by the advertising content server 298a before the advertising content 302a is generated or during the filtering process. Similar to FIG. 14(b), FIG. 15(b) illustrates that upon ending a phone call, the new display 332a goes back to the homescreen 40 as would normally be the case, but with the homescreen 40 resized to fit within the available space. The advertising application display 331 is kept running until the playlist or a certain amount of “runtime” is considered to be complete. The amount of time that the advertising application display 331 is kept running can be configured in various ways. If the advertising content 302a is simply queued up and played according to a playlist, the display 331 may be configured to persist until all of the content is played or until the user skips to the end. In another example, the Skip control 335 may be removed thus requiring that each item is played at least once (subject to use of the Replay control 336) before closing the advertising application display 331 and resuming normal screen control. The advertising application display 331 may be configured to play at specified times or during use of certain applications or both. The actual intervals and conditions are typically dictated by the organization or entity that controls the use of the advertising application 60, such as the host system 250.

It may be noted that the advertising content server 298a in one embodiment, may reside at an intermediary such as the host system 250 or router 26 as shown in FIG. 12 or another intermediary such as an ISP or trusted relay. In this way, there can be assumed a certain level of control over the confidentiality of user information that relates to location and advertising content so that such information will be used only for the purposes of subsidizing the user's service or on the basis that ownership of the mobile device 100 is with the entity controlling the content server 298a. This is particularly suitable for systems that are configured for continuously routing all forms of pushed information from a host system 250 to the mobile device 100 as described in detail herein. This is due to the fact that such systems already require and use user information and location information for pushing data to the mobile device 100 and thus the advertising content server 298a can be implemented with anonymity and without compromising privacy. Since this information is already available, the host system 250 or router 26 can regulate the use of the advertising application 60 by pushing IT policies to the mobile device 100. Similarly, the already established registration and billing services 70 can handle advertising revenue collected from the advertising content providers 329, and subsidies for the user.

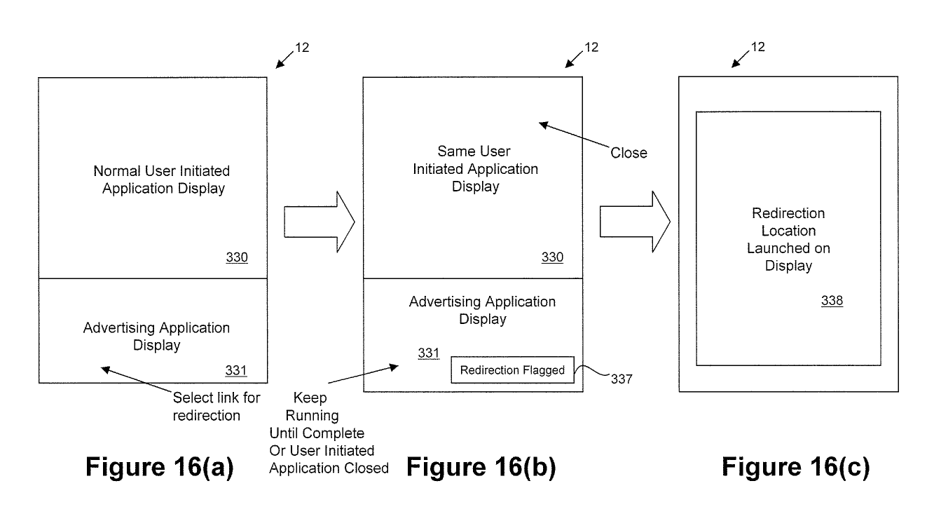

The advertising application 60 can also be configured to take over full screen control in response to user interactions, as shown in FIGS. 16(a) to 16(c). Again, the initiation and duration of the advertising application display 331 can be strictly controlled by the advertising application 60 according to specific rules and intervals; however, being given the opportunity to collect further revenue, e.g. by executing a selection of a link, icon or other redirection mechanism such as a “click-through” or touch; additional screen control can be imposed. As can be seen in FIGS. 16(a) and 16(b), the advertising application display 331 is given a separate and distinct display channel that subsists for a certain predetermined amount of time. While the display 331 is running, a redirection is detected and is flagged using a redirection flag 337 as shown in FIG. 16(b). The redirection flag 337 can be used to remind the user that they have queued up an advertising event for when the current session is finished. This session can terminate either when the application 330 is closed or when the advertising application display 331 times out.

Typically, the later of these two events would be chosen; however, redirections (e.g. after selecting a link) may be given higher priority than items simply played through the advertising application display 331. In this case, the redirection ad may be displayed immediately and the redirection flag 337 would not be needed. Once the redirection display 338 (e.g. browser opened and web page displayed) is launched, screen control can be maximized to full screen as shown in FIG. 16(c). Once the user is finished with the redirection display 338 (or after a timeout etc.), control may go back to the advertising application display 331 to finish out the playlist (if the redirection is displayed immediately), or can proceed back to the homescreen 40 or other application depending on what is or was running at the time of the redirection. It can thus be seen that additional and changing levels of screen control can be imposed to add further value to an advertiser and in return better subsidies for the end user. It will be appreciated that the host system 250 or router 26 or other intermediary may tailor the amount and frequency of use of the advertising application 331 according to permissions obtained from the users and thus according to user-chosen service packages. For example, premium users may experience lower data access fees in exchange for greater exposure to the advertising content 302. Again, systems such as those utilizing a host system 250 or router 26 or both are particularly suitable for integrating such services directly into normal billing and registration procedures. This, in combination with the inherent anonymity, enables such systems to provide an improved advertising experience for both the advertising content providers 329 and the users.

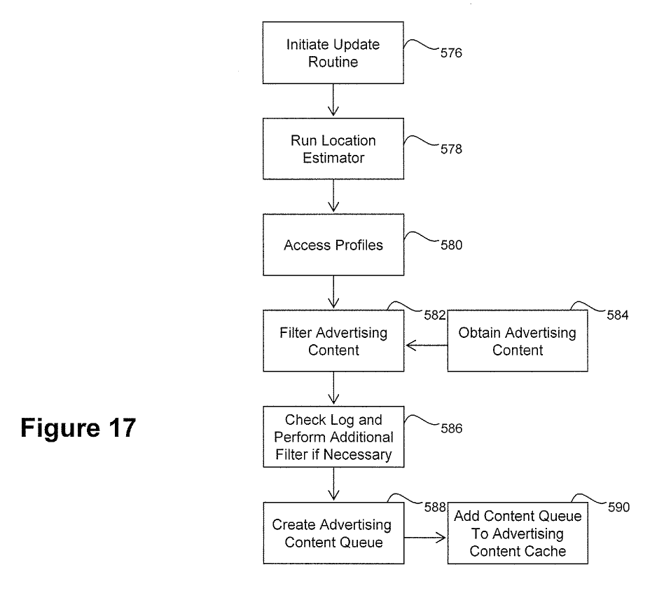

The advertising application 60 may only have access to the advertising content 302a at certain times due to available connections with the advertising content server 298a. Therefore, rather than rely on real time streaming of advertising content 302a, as noted above, the advertising content cache 63 can be used to periodically refresh, update or replace advertising content 302a so that the user can be exposed to new and different content. Turning now to FIG. 17, an example routine for updating the advertising content cache 63 will now be described. It may be noted that the flow diagram shown in FIG. 17 is more applicable to the configuration shown in FIG. 13 where all operations take place on the mobile device 100. It will be appreciated that certain ones of these operations may be done in a different order or in parallel with others of the operations, in particular if performed using the configuration of FIG. 12. At 576, an update routine is initiated by the mobile device 100. In this example, the advertising content 327 that is received or downloaded is filtered before being added to the advertising content cache 63 and such filtering is performed using both location and user preference data. At 578, the advertising content server 298a, 298b initiates or obtains location data 300 from the location estimator 54 as described above. The advertising content server 298a, 298b also accesses or receives data from the advertising profile 62 and if applicable, the location profile at 580 to determine user preferences, a user location, user requests 324 and demographic data 320. The advertising content server 298a, 298b may then perform a filtering operation at 582 using the location data 300 and the profiles 62, 64. It can be seen in FIG. 17 that the unfiltered advertising content 327 would have been obtained at some earlier time at 584. The unfiltered advertising content 327 may also be the source for triggering the update routine rather than relying on an interval tracked by the mobile device 100. As noted above, the timing and criteria used to determine when and how to fetch, download, receive or otherwise obtain the data 327 is dependent on the connections available with the advertising content server 298a in the configuration shown in FIG. 12 or with the advertising content providers 329 as would be the case in the configuration shown in FIG. 13.

Once the filtering operation 582 is completed at 582, or at the same time, the advertising content server 298a, 298b may then check the content log 323 or other archived data to determine if additional filtering is required at 586. This can be done to remove content that has already been viewed or has since been deemed irrelevant. The filtered advertising content 302a, 302b thus remains, which may then be organized into advertising content queues or playlists at 588. This avoids the need for intelligence at the time of running the advertising application 60 since the next playlist or queue can simply be loaded rather than having to selectively choose which items to play at that time. The filtered advertising data 302a, 302b, either in bulk or as organized into playlists, is then added to the advertising content cache 590, then accessed at some other time. It can be appreciated that the playlists or queues can be chosen in various ways, which would be dependent on the content available, IT policies for the user, user preferences, a user's service level and any other rules that may be imposed on the advertising application 60 in the various configurations. Similarly, the filtering operation at 582 can vary depending on the user's input, the input or restrictions imposed by the host system 250 or router 26 or other intermediary among other things.

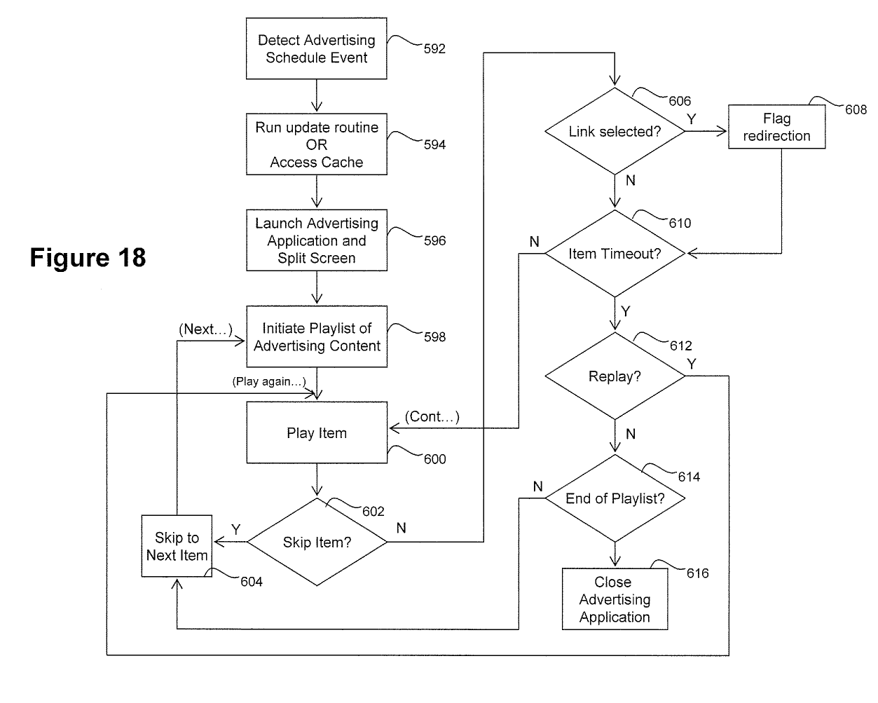

Turning now to FIG. 18, operation of the advertising application 60 will now be exemplified. At 592, the mobile device 100 first detects an advertising schedule event, which determines when to launch the advertising application 60 and impose the screen control shown in FIGS. 14 to 18. The schedule event can be any one or more of: being based on a timer utilizing a predetermined interval (an internal, time-based trigger); being based on which application is currently running; or being based on the detection of an external event. If based on which application is currently running, the mobile device 100 determines appropriate or pertinent times to launch the advertising application display 331 such as during a phone call as shown in FIG. 15 or every hour. If based on an external event, the mobile device 100 may be executing instructions received from a remote advertising content server 298a or may simply be running new advertising content 302a as it is received.

The detection of a schedule event at 592 then triggers the initiation of the advertising application 60. At 594, the advertising application 60 or the advertising content server 298b (whichever is appropriate given the configuration) first determines if the advertising content cache 63 can be updated and then accesses the next playlist or group of items from the advertising content cache 63. Updating the cache 63 at this time would typically only be needed if the schedule event is based on new content that is received or if the advertising content 302a is streaming to the mobile device 100 in real time. The advertising application 60, when launched, then splits the display 12 into two or more distinctly running applications and imposes the screen control discussed above at 596. At 598, the advertising application 60 then launches the playlist or queue of items through the advertising application display 331 at 598. At 600, each item is played according to the playlist or queue.

While the advertising content 302a, 302b is being presented to the user, various user interactions may be sensed. At 602, the advertising application 60 determines if the item currently being played has been skipped, i.e. if the user has selected the Skip option 335. If so, the current item is skipped at 604 and control returns to 598 where the next item is played at 600. If the item is not skipped, the advertising application 60 then determines if a link or other redirection mechanism has been sensed at 606. If so, the redirection may be flagged at 608 (or as discussed above, the redirection display 338 launched immediately according to a priority). If a redirection has not been sensed, the advertising application 60 then determines if the item has “timed out” at 610. This may be due to a certain amount of time having elapsed or the user having indicated that it is done viewing that item (i.e. based on the user controls provided to the user). If the item has not timed out at 610, the item continues to play and goes through the same set of determinations until a timeout is sensed. If a timeout is sensed at 610, the advertising application determines if the Replay option 336 has been selected at 612. If so, the same item is played again. If not, the advertising application determines if the end of the playlist has been reached (i.e. a time out for that session of the advertising application 60) at 614. If so, the advertising application 60 is closed at 616. If not, control skips to the next item at 604 and the process repeats until the end of the playlist is reached. It will be appreciated that the determinations shown in FIG. 18 are for illustrative purposes only to show how the user controls shown in FIG. 15 may be used. Other user controls can also be provided according to the way in which the advertising application 60 is used and according to the IT policies set by an administrator or the user.

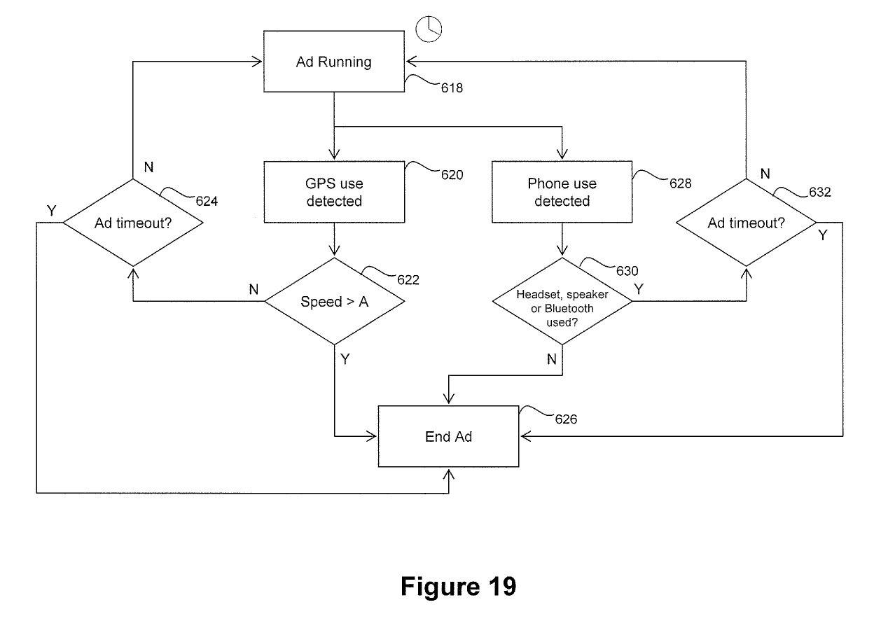

The advertising application 60 is intended to be intelligently launched at appropriate times and to impose screen control so that the advertising content 302a, 302b is more likely to be effective. There may be instances other than those discussed above, where launching the advertising application display 331 would be ineffective or distracting and thus certain disablement options can be included into the configuration of the advertising application 60. These may include but should not be considered limited to sensing that the user is driving and sensing that the user is on the phone but the screen is not visible to them. Collectively, these may be considered user behavior override events, which are indicative of uses of the mobile device 100 that are not conducive to use of the advertising application 60. In other words, there may be times when the advertising content 302a, 302b would be distracting or overlooked by the user, despite the other normal operating conditions discussed above. Turning now to FIG. 19, an example showing an override routine that can be run by the advertising application 60 will now be described.

At 618, the advertising application display 331 is currently running, as indicated by the timer. While the advertising content 302a, 302b is being displayed, e.g. according to the flow diagram shown in FIG. 18, a movement event may be detected at 620 or a phone condition detected at 628. In this example, the movement event at 620 involves periodically checking the GPS receiver 121 to determine if the mobile device is moving above a predetermined speed. This may indicate that the user is driving, walking or otherwise moving in a way that would cause the advertising content 302a, 302b to be distracting and dangerous or overlooked. It will be appreciated that exceptions may be considered such as when the user is on an airplane travelling at high speeds, or while commuting on a bus, train or other transportation vehicle which the user is not responsible for operating. If the speed is determined to be greater than a threshold A (and no exception is indicated), the advertising application 60 may be shut down or disabled until it is determined that the speed drops below A. Movement may also be sensed using an accelerometer or other device. If the speed does not exceed A, the advertising application 60 may then check for an ad timeout at 624 and keep running at 618 or end the advertising session at 626 accordingly. At 628, the phone condition is detected. The phone condition can indicate that the user is holding the mobile device 100 to their ear rather than using Bluetooth or a hands free system. In this situation, the display 12 is hidden from the user and thus the advertising session can be ended at 626 or an ad timeout determined at 632, similar to the movement detection described above. It may be noted that such disablement features can be imposed by the user, through the advertising profile 62 or imposed by the intermediary such as the host system 250 or router 26. In this way, safety and effectiveness can be enhanced in various states.

It can therefore be seen that the advertising application 60 can be used on the mobile device 100 to impose screen control restrictions on a portion of the mobile device display 12, in order to provide a controllable mechanism for displaying advertising content 302. The advertising application 60 causes the display screen 12 to be split into two or more portions, with an advertising application display 331 having limited screen control so that advertising content 302 can be played according to a schedule or at event driven times as dictated by an administrator or other entity so that the mobile device's services may be subsidized in part by the advertising content providers 329. The limited screen control associated with the advertising application display 331 enables the advertising application 60 to control how long the advertising content 302 is displayed such that the advertising application display 331 may persist on the display 12 regardless of which applications are running on the remainder of the display 12. In this way, the advertising display 331 runs independent of the normal, user initiated applications 330 and thus does not need to consider screen placement within the normally running applications and is not dependent on when the user decides to close down or switch between applications.

The advertising application 60 can be used with the location estimator 54 to narrow and categorize the advertising content 302 at least in part based on location, either physical location or preferred location or both. The location estimator 54 can therefore improve the filtering of the advertising content 327 and the advertising application 60 illustrates one example of an application making use of an LBS 298. The different configurations described herein are for illustrative purposes only and it will be appreciated that variations of these configurations can be made while utilizing the principles discussed herein.

It will be appreciated that the particular options, outcomes, applications, screen shots and icons shown in the figures and described above are for illustrative purposes only and many other variations can be used according to the principles described.

Although the above has been described with reference to certain specific embodiments, various modifications thereof will be apparent to those skilled in the art as outlined in the appended claims.

1. A method for providing multimedia content on a mobile device, said method comprising:
dividing a display of said mobile device into a first portion containing at least one application having full screen control and a second portion containing a multimedia application display, said first and second portions being controlled independently of each other, said second portion providing limited screen control to said user;
using said multimedia application display in said second portion according to one or more predetermined criteria to display user-specific multimedia content; and
upon said one or more predetermined criteria being met, closing said second portion and restoring said display to include only said first portion.

2. The method according to claim 1 wherein said one or more predetermined criteria comprise a periodic interval independent of user action and wherein said one or more predetermined criteria are met by providing said multimedia application display under predetermined conditions, said providing said multimedia application display persisting according to said predetermined conditions independently of user interaction with said at least one application.

3. The method according to claim 2 wherein said predetermined conditions comprise either completion of a list of multimedia content items or a predetermined amount of time having elapsed.

4. The method according to claim 2 further comprising providing said limited screen control through at least one of a skip option or a replay option.

5. The method according to claim 1 wherein said multimedia content comprises advertising content.

6. The method according to claim 5 wherein said advertising content is filtered by at least one of an advertising content server located remote from said mobile device, and an intermediary configured for pushing information to said mobile device.

7. The method according to claim 5 further comprising upon sensing selection of a link for redirecting to said advertising content, launching a further application containing further advertising content pertaining to an item associated with said redirection.

8. The method according to claim 7 comprising flagging said redirection in said second portion or launching said further application.

9. The method according to claim 1 further comprising sensing a user control event indicative of low user attention to said display and closing said second portion until said user control event subsides.

10. The method according to claim 1, further comprising generating a playlist of said filtered multimedia content using said predetermined criteria, said predetermined criteria comprising at least one of available content, information technology (IT) policies pertaining to said mobile device, user preferences, a service level or one or more rules specified by an application performing said method.

11. A computer readable medium comprising computer executable instructions for performing the method according to claim 1.

12. A mobile device comprising a display, one or more input mechanisms and a memory storing a multimedia application, said mobile device being configured for:
dividing said display into a first portion containing at least one application having full screen control and a second portion containing a display for said multimedia application, said first and second portions being controlled independently of each other, said second portion providing limited screen control to said user;
using said multimedia application display in said second portion according to one or more predetermined criteria to display user-specific multimedia content; and
upon said one or more predetermined criteria being met, closing said second portion and restoring said display to include only said first portion.

13. The mobile device according to claim 12 wherein said one more predetermined criteria comprise a periodic interval independent of user action; and wherein said one or more predetermined criteria are met by providing said multimedia application display under predetermined conditions, said providing said multimedia application display persisting according to said predetermined conditions independently of user interaction with said at least one application.

14. The mobile device according to claim 13 wherein said predetermined conditions comprise either completion of a list of multimedia content items or a predetermined amount of time having elapsed.

15. The mobile device according to claim 13 further configured for providing said limited screen control through at least one of a skip option or a replay option.

16. The mobile device according to claim 12 wherein said multimedia content comprises advertising content.

17. The mobile device according to claim 16 wherein said advertising content is filtered by at least one of an advertising content server located remote from said mobile device, and an intermediary configured for pushing information to said mobile device.

18. The mobile device according to claim 16 further configured for upon sensing selection of a link for redirecting to said advertising content, launching a further application containing further advertising content pertaining to an item associated with said redirection.

19. The mobile device according to claim 18 further configured for flagging said redirection in said second portion or launching said further application.

20. The mobile device according to claim 12 further configured for sensing a user control event indicative of low user attention to said display and closing said second portion until said user control event subsides.

21. The mobile device according to claim 12, further configured for: generating a playlist of said filtered multimedia content using said predetermined criteria, said predetermined criteria comprising at least one of available content, information technology (IT) policies pertaining to said mobile device, user preferences, a service level or one or more rules specified by an application performing said method.
